(19) United States
(12) Patent Application Publication
(10) Pub. No.: US 2006/0154701 A1
(43) Pub. Date: Jul. 13, 2006

(54) Hinge assembly for foldable electronic device

(75) Inventors: Ming-Feng Ma, Shenzhen (CN); Rui-Hao Chen, Shenzhen (CN); Chia-Hua Chen, Tu-cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO.,LTD, Shindian City (TW)

(21) Appl. No.: 11/285,517

(22) Filed: Nov. 21, 2005

(30) Foreign Application Priority Data
Nov. 24, 2004 (CN) 200410052435.7

(51) Int. Cl. H04M 1/00

(52) U.S. Cl. 455/575.3

(57) ABSTRACT

A hinge assembly (100) includes a can (11), an elastic member (20), a shaft (31) and a pin (40). The can has a body (111) and a center cavity (113). The body defines a guiding slit (114) therein, and the guiding slit communicates with the center cavity. The shaft defines a pin hole (318) therein, and the shaft is partly received in the center cavity of the can. The elastic member is received in the center cavity of the can with one end abutting the can and an opposite end abutting the shaft. One end of the pin is received in the guiding slit of the can and is movable along the guiding slit, and an opposite end of the pin is engaged in the pin hole of the shaft.

### CROSS-REFERENCE TO RELATED APPLICATION

This application is related to another patent application inventors: Ming-Feng Ma et al., entitled “HINGE ASSEMBLY FOR FOLDABLE ELECTRONIC DEVICE”, filed concurrently herewith, and with the same assignee as the instant application. This disclosure of the above identified application is incorporated herein by reference.

### FIELD OF THE INVENTION

The present invention generally relates to hinge assemblies, and more particularly to a hinge assembly for hinging together housings of foldable electronic devices such as mobile telephones, electronic notebooks, and so on.

### BACKGROUND

With the development of the technologies of wireless communication and information processing, portable electronic devices such as mobile telephones and electronic notebooks are now in widespread use. These electronic devices enable consumers to enjoy the convenience of high technology services anytime and anywhere. Foldable electronic devices are particularly favored by consumers for their convenience.

Generally, foldable electronic devices have most of the electronics in one housing, called the body. The other housing, called the cover, normally contains fewer electronic components than the body. Other foldable electronic devices have all the electronics in the body, thus the cover contains no electronics and serves only to cover a keypad and a display of the body. Various types of hinge assemblies are used to join a body and a cover of a foldable electronic device, so that the cover can unfold up from and fold down upon the body.

As represented in FIG. 8, a conventional hinge assembly for a foldable radiotelephone includes a spring 762 and two hinge pins 764, 768. The hinge pins 764, 768 are disposed in a tubular hinge arm 742 formed at an end of a cover 74, and corresponding bushings 722 are formed in a body 72. The spring 762 is positioned between the hinge pins 764, 768, and at all times forces the hinge pins 764, 768 outwardly from the cover 72 toward the body 74.

Such a hinge assembly is suitable for some foldable radiotelephones. However, the hinge assembly includes a variety of individual pieces that must be installed within the foldable radiotelephone when the foldable radiotelephone is assembled. This does not meet the growing trend for foldable radiotelephone manufacturers to use integrated one-piece hinge assemblies, which can be quickly and easily press-fitted into foldable radiotelephone sub-assemblies during manufacturing.

What is needed, therefore, is a hinge assembly which is integrated and provides easy assembly.

### SUMMARY

In a preferred embodiment herein, a hinge assembly for a foldable electronic device is provided. The hinge assembly includes a can, a shaft, an elastic member, and a pin. The can has a body and a center cavity. The body defines a guiding slit therein, and the guiding slit communicates with the center cavity. The shaft defines a pin hole therein, and the shaft is partly received in the center cavity of the can. The elastic member is received in the center cavity of the can with one end abutting the can and an opposite end abutting the shaft. One end of the pin is received in the guiding slit of the can and is movable along the guiding slit, and an opposite end of the pin is engaged in the pin hole of the shaft.

Other advantages and novel features of various embodiments will become more apparent from the following detailed description thereof when taken in conjunction with the accompanying drawings, in which:

### BRIEF DESCRIPTION OF THE DRAWINGS

FIG. 1 is an isometric view of a foldable electronic device with a hinge assembly according to a first preferred embodiment of the present invention;

FIG. 2 is an enlarged, exploded, isometric view of the hinge assembly of FIG. 1;

FIG. 3 is an assembled view of the hinge assembly of FIG. 2;

FIG. 4 is an exploded, isometric view of a hinge assembly according to a second preferred embodiment of the present invention;

FIG. 5 is an assembled view of the hinge assembly of FIG. 4;

FIG. 6 is a cross-sectional view of the hinge assembly of FIG. 5, taken along line VI-VI thereof;

FIG. 7 is an exploded, isometric view of a hinge assembly according to a third preferred embodiment of the present invention; and

FIG. 8 is an exploded, isometric view of a conventional hinge assembly for a foldable radiotelephone.

### DETAILED DESCRIPTION OF THE PREFERRED EMBODIMENTS

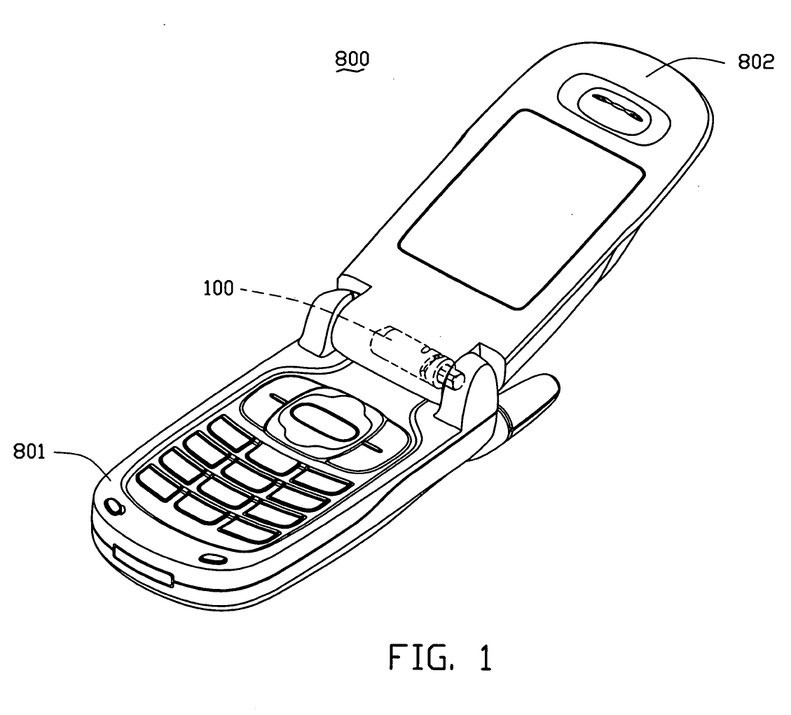

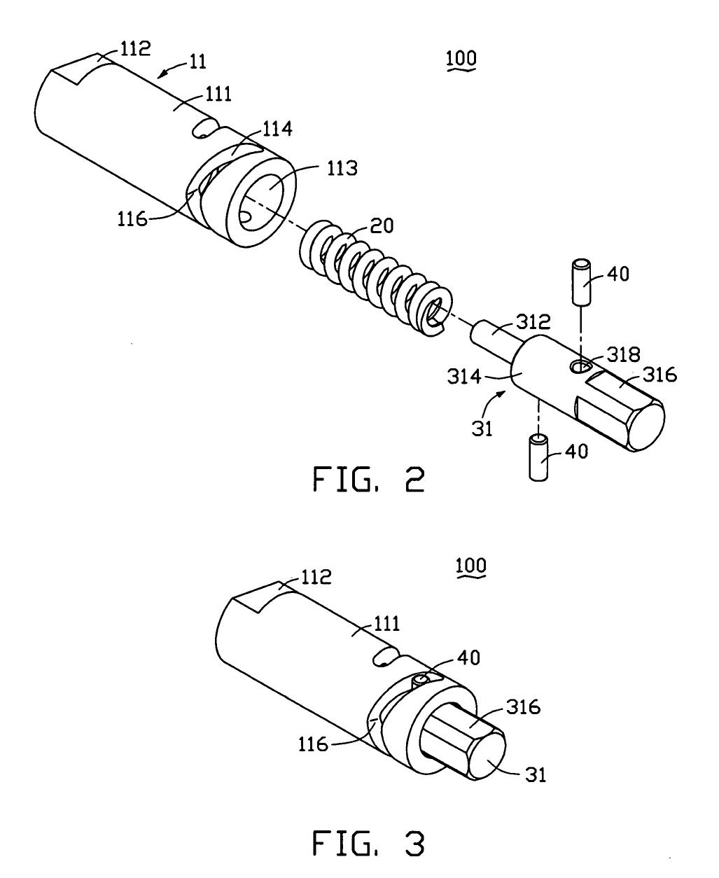

FIGS. 1-3 show a hinge assembly 100 according to a first preferred embodiment of the present invention. The hinge assembly 100 is used to interconnect a body 801 and a cover 802 of a foldable electronic device 800. The hinge assembly 100 includes a can 11, a compression spring 20, a shaft 31, and two pins 40. The compression spring 20 and the shaft 31 are received in the can 11 by the pins 40.

The can 11 is in the form of a hollow cylinder, and includes a tubular body 111 and a center cavity 113. The center cavity 113 is defined through the body 111 along a center axis thereof. The body 111 is closed at a first end thereof, and open at an opposite second end thereof. A keyed head 112 is formed at the first end of the body 111. The keyed head 112 is engaged with the cover 802 of the foldable electronic device 800 so that the can 11 is rotatable with the cover 802. Two guiding slits 114 functioning as guiders are defined in the second end of the body 111, in communication with the center cavity 113. Each guiding slit 114 is generally V-shaped, and has an elbow portion 116.

The shaft 31 is essentially in the form of a round rod, and includes a first pole portion 312 with a smaller diameter and a second pole portion 314 with a larger diameter. The two pole portions 312, 314 adjoin each other and are coaxial with each other. A lock member 316 is formed at an end of the second pole portion 314. The lock member 316 is an irregular polygonal block and is engaged with the body 801 of the foldable electronic device 800, so that the shaft 31 is fixed relative to the body 801. Two pin holes 318 are defined in two opposite sides of a peripheral wall of the second pole portion 314. The pin holes 318 are offset from each other relative to a center axis of the second pole portion 314, and correspond to the guiding slits 114 of the can 11 respectively. An axis of each pin hole 318 is perpendicular to a center axis of the shaft 31.

In assembly of the hinge assembly 100, the compression spring 20 and the shaft 31 are inserted into the center cavity 113 of the can 11. The compression spring 20 is located around the first pole portion 312 of the shaft 31. One end of the compression spring 20 abuts the first end of the can 11, and the opposite end of the compression spring 20 abuts an end of the second pole portion 314 of the shaft 31. The shaft 31 is rotated until the pin holes 318 of the shaft 31 respectively align with the guiding slits 114 of the can 11. One end of each pin 40 is engaged in the corresponding pin hole 318, and an opposite end of each pin 40 is received in an end of the corresponding guiding slit 114. In this position, the compression spring 20 is slightly compressed, and the lock member 316 protrudes out from the second end of the can 11. The hinge assembly 100 is thus completely assembled, as shown in FIG. 3. This position of the hinge assembly 100 corresponds to a closed position of the foldable electronic device 800.

To open the foldable electronic device 800, the cover 802 is manually rotated up from the body 801. Hence the can 11 rotates relative to the shaft 31. The pins 40 move out from engagement with in ends of the guiding slits 114, and slide to the elbow portions 116 of the guiding slits 114. In this process, the first end of the can 11 axially moves toward the lock member 316, and the compression spring 20 is compressed. Once the pins 40 slide past apexes of the elbow portions 116, the compression spring 20 decompresses and drives the first end of the can 11 to move axially away from the lock member 316. Accordingly, the can continues to rotate relative to the shaft 31 in an opening direction, until the pins 40 are engaged in opposite ends of the guiding slits 114 respectively. The cover 802 is thus automatically opened to a fully open position. The process of closing the cover 802 is substantially the reverse of the above-described opening process.

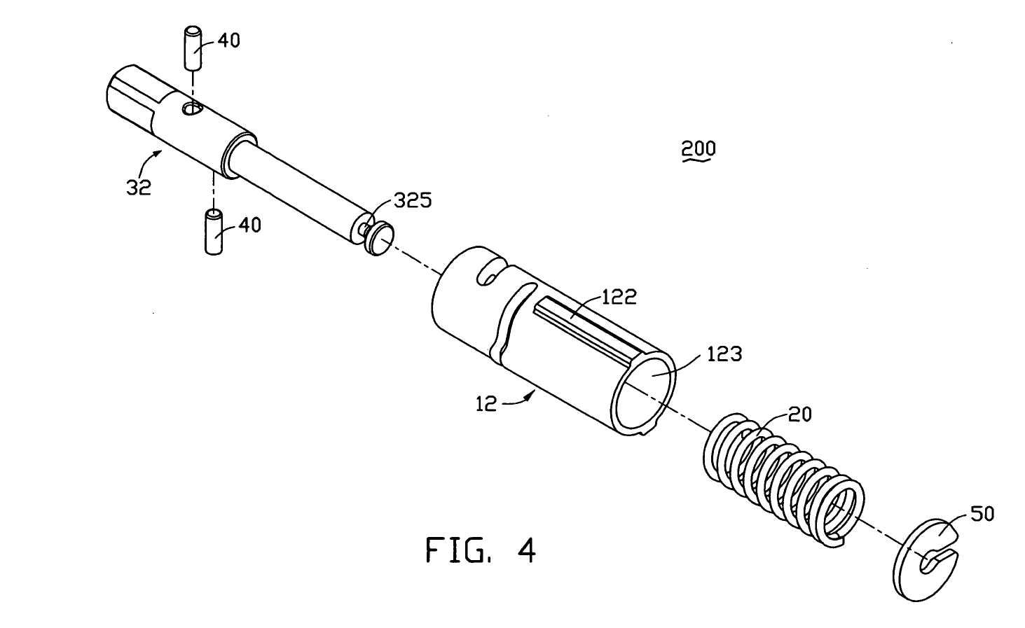

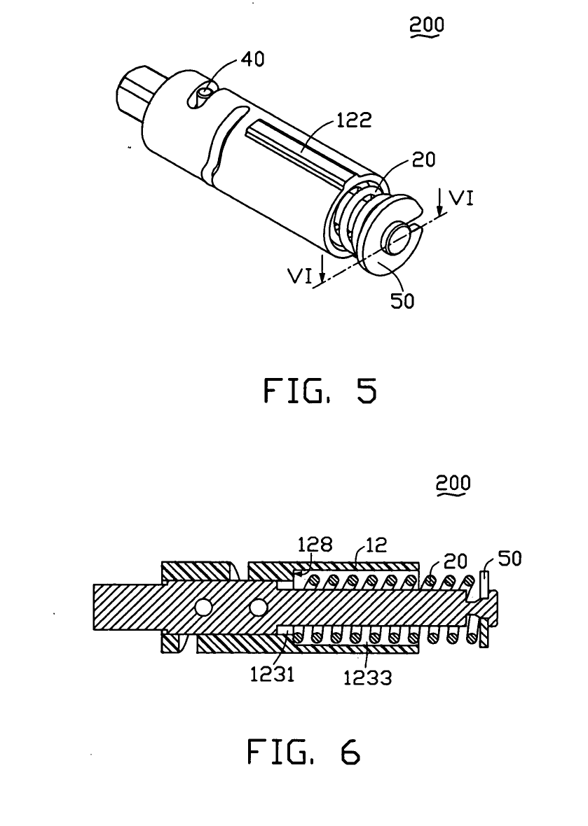

Referring to FIGS. 4-6, a hinge assembly 200 according to a second preferred embodiment of the present invention is similar to the hinge assembly 100 of the first preferred embodiment. The hinge assembly 200 includes a can 12, a compression spring 20, a shaft 32, two pins 40, and a disk 50.

The can 12 is similar to the can 11 of the hinge assembly 100, except that the can 12 has a protrusion 122 and a center cavity 123. The protrusion 122 is formed on a peripheral wall of the can 12, and is engaged with the cover 802 of the foldable electronic device 800 so that the can 12 is rotatable with the cover 802. The center cavity 123 is defined through the can 12 along a center axis thereof. The center cavity 123 comprises a first cavity 1231 with a smaller diameter, and a second cavity 1233 with a larger diameter. The first cavity 1231 and the second cavity 1233 adjoin each other and are coaxial with each other, thereby defining an inner, annular step surface 128 therebetween.

The shaft 32 is similar to the shaft 31 of the hinge assembly 100, except that the shaft 32 defines an annular slot 325 in one end thereof.

The compression spring 20 and the shaft 32 are received in the can 12 by means of the pins 40 and the disk 50. The disk 50 is snappingly secured in the annular slot 325 of the shaft 32. One end of the compression spring 20 abuts the step surface 128 of the can 12, and the opposite end of the compression spring 20 abuts the disk 50.

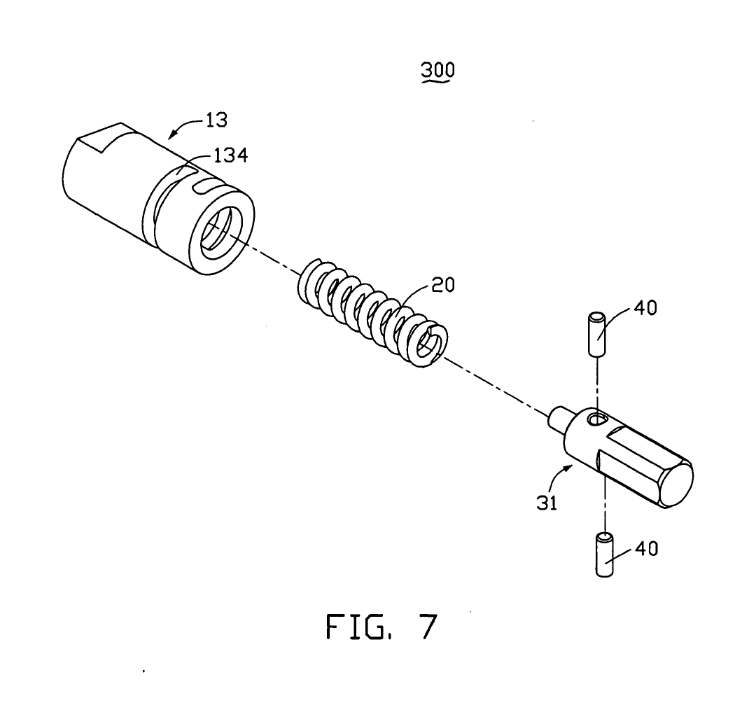

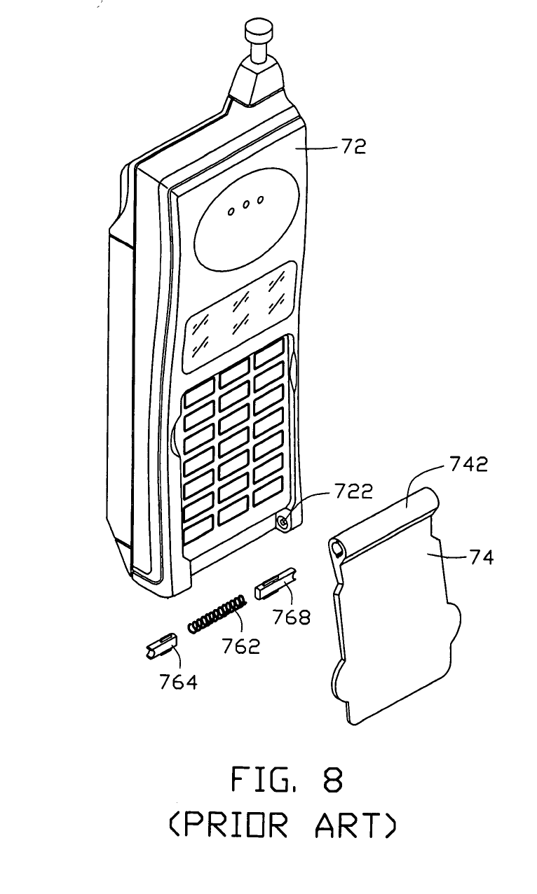

Referring to FIG. 7, a hinge assembly 300 according to a third preferred embodiment of the present invention is similar to the hinge assembly 100 of the first preferred embodiment. The hinge assembly 300 includes a can 13, a compression spring 20, a shaft 31, and two pins 40.

The can 13 is similar to the can 11 of the hinge assembly 100, except that the can 13 has two guiding slits 134 functioning as the guider. The guiding slits 134 are perpendicular to a center axis of the can 13. Each guiding slit 134 generally spans half a circumference of the can 13. The guiding slits 134 are generally located in opposite semi-circumferential portions of the can 13, such that the guiding slits 134 are spaced from each other and parallel to each other. During rotation of the cover 802 of the foldable electronic device 800, the compression spring 20 enables the pins 40 to remain stably in position anywhere in the guiding slits 134. That is, the cover 802 can remain stable relative to the body 801 at any of a plurality of positions at which the pins 40 resiliently contact walls of the can 13 in the guiding slits 134.

It is to be understood that the compression spring 20 may alternatively be another kind of suitable elastic member such as a resilient cylinder.

It is believed that the present embodiments and their advantages will be understood from the foregoing description, and it will be apparent that various changes may be made thereto without departing from the spirit and scope of the invention or sacrificing all of its material advantages. The examples hereinbefore described are merely preferred or exemplary embodiments of the invention.

We claim:

1. A hinge assembly for a foldable electronic device, comprising:
a can including a body and a center cavity, the body defining a guiding slit therein, and the guiding slit communicating with the center cavity;
a shaft including a pin hole defined therein, and the shaft being partly received in the center cavity of the can;
an elastic member received in the center cavity of the can, one end of the elastic member abutting the can, and an opposite end of the elastic member abutting the shaft; and
a pin, one end of the pin being received in the guiding slit of the can and movable along the guiding slit, and an opposite end of the pin being engaged in the pin hole of the shaft.

2. The hinge assembly as claimed in claim 1, wherein the body of the can comprises a keyed head at one end thereof, for engaging with a cover of the foldable electronic device so that the can is rotatable with the cover.

3. The hinge assembly as claimed in claim 1, wherein the body of the can comprises a protrusion on a peripheral wall thereof, for engaging with a cover of the foldable electronic device so that the can is rotatable with the cover.

4. The hinge assembly as claimed in claim 1, wherein the guiding slit of the can is generally V-shaped.

5. The hinge assembly as claimed in claim 1, wherein the guiding slit of the can is perpendicular to a center axis of the can.

6. The hinge assembly as claimed in claim 1, wherein the can is closed at a first end thereof and open at an opposite second end thereof, and said one end of the elastic member abuts the first end of the can.

7. The hinge assembly as claimed in claim 1, wherein the center cavity of the can comprises a first cavity with a smaller diameter and a second cavity with a larger diameter, thereby defining a step surface therebetween, and said one end of the elastic member abuts the step surface.

8. The hinge assembly as claimed in claim 1, wherein the elastic member is selected from the group consisting of a compression spring and a resilient cylinder.

9. The hinge assembly as claimed in claim 1, wherein the shaft further includes a lock member provided at an end thereof, and the lock member is for engaging with a body of the foldable electronic device so that the shaft is fixed relative to the body.

10. The hinge assembly as claimed in claim 9, wherein the lock member is an irregular polygonal block.

11. The hinge assembly as claimed in claim 1, wherein the shaft further includes a first pole portion with a smaller diameter and a second pole portion with a larger diameter, and the pin hole is defined in a peripheral wall of the second pole portion.

12. The hinge assembly as claimed in claim 1, wherein the shaft further includes a disk, and said opposite end of the elastic member abuts the disk.

13. The hinge assembly as claimed in claim 12, wherein the shaft further includes a slot defined in one end thereof, and the disk is secured in the slot.

14. A foldable electronic device, comprising:
a cover;
a body; and
a hinge assembly rotatably connecting the cover and the body, the hinge assembly comprising:
a can engaged with one of the cover and the body, the can defining a guiding slit therein;
a shaft engaged with the other of the cover and the body;
an elastic member, one end of the elastic member abutting the can, and the other end of the elastic member abutting the shaft; and
a follower, one end of the follower being received in the guiding slit of the can and movable relative to the guiding slit, and the other end of the follower being fixed to the shaft.

15. An electronic device comprising:
a body of said electronic device;
a cover of said electronic device disposed beside said body and movable relative to said body between a first position thereof where said cover abuts against a side of said body to cover said side and a second position thereof where said cover moves away from said side to expose said side; and
a hinge assembly disposed between said body and said cover so as to supportively control movement of said cover relative to said body, said hinge assembly comprising a can engagably movable with one of said body and said cover, and a shaft extendable in said can and engagably movable with the other of said body and said cover, a pin formed at one of said can and said shaft and extendable toward the other of said can and said shaft so as to movably engage with a guider formed at said other of said can and said shaft, movement of said pin engagably guidable by said guider capable of resulting in movement of said shaft relative to said can along an axial direction of said can so as to guidably control said movement of said cover.

16. The electronic device as claimed in claim 15, wherein said guider is a guiding slit extending at said other of said can and said shaft, an offset is defined along said axial direction of said can between at least two portions of said slit.
